(19) United States
(12) Patent Application Publication
(10) Pub. No.: US 2020/0302434 A1
(43) Pub. Date: Sep. 24, 2020

(54) VIRTUAL NETWORK FUNCTION SERVICES USAGE TRACKING USING A DISTRIBUTED TRUST-BASED NETWORK

(71) Applicant: HEWLETT PACKARD ENTERPRISE DEVELOPMENT LP, Houston, TX (US)

(72) Inventors: Aseem Sethi, Bangalore (IN); Mark Andrew Denny, Santa Clara, CA (US)

(21) Appl. No.: 16/359,444

(22) Filed: Mar. 20, 2019

(51) Int. Cl. G06Q 20/38; G06Q 30/04; G06F 16/182; G06Q 20/06; G06F 9/455

(52) U.S. Cl. CPC G06Q 20/382; G06Q 30/04; G06F 2009/45595; G06Q 20/065; G06F 9/45558; G06F 16/1824

(57) ABSTRACT

One or more nodes in a distributed trust-based network may receive an indication of one or more data transactions by an entity at a virtual network function service and a cryptocurrency transaction from the entity. A smart contract may record the cryptocurrency transaction in a distributed ledger in the distributed trust-based network. The smart contract may track usage of the virtual network function service by the entity by updating a transaction record associated with the entity in the smart contract to include an amount of data transacted by the virtual network function service for the one or more data transactions, where the transaction record is stored in the distributed ledger in the distributed trust-based network. The smart contract may generate billing information for the usage of the virtual network function service by the entity based at least in part on the transaction record associated with the entity.

### BACKGROUND

Virtual network function is a technology where network functions previously performed on proprietary hardware that are physically located on-site in an enterprise are virtualized so that they can be performed using general purpose computer hardware. A virtual network function can execute across one or more computing devices, and a single computing device may perform one or more virtual network functions. Such virtual network functions may include firewalls, load balancers, deep packet inspectors, network address translators, and the like. Entity may subscribe to virtual network function services provided by vendors in order to use virtual network functions provided by such virtual network function services for the entity's networks and may pay the provider of such services for the usage of the virtual network function services.

The description provided in the background section should not be assumed to be prior art merely because it is mentioned in or associated with the background section. The background section may include information that describes one or more aspects of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for secure and distributed tracking of the usage of virtual network function services.

FIG. 2 is a block diagram illustrating an example node in the example distributed trust-based network of FIG. 1 according to certain aspects of the disclosure.

FIG. 3A illustrates the example billing records shown in FIG. 2.

FIG. 3B illustrates the example virtual network function records shown in FIG. 2.

FIG. 4 illustrates an example process for secure and distributed tracking of the usage of virtual network function services using the example node of FIG. 2 in the example distributed trust-based network of FIG. 1.

FIG. 5 is a block diagram illustrating an example computer system with which example nodes in FIGS. 1 and 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

### General Overview

The disclosed system provides for tracking and billing for the usage of virtual network function services via the use of a distributed trust-based network. The distributed trust-network provides a distributed ledger that records the usage of virtual network function services by entities and may provide a smart contract that may track the usage of virtual network function services by entities and bill entities for their tracked usage of virtual network function services. When an entity uses a virtual network function service to perform one or more data transactions, the entity may send to the smart contract an indication of the entity's usage of the virtual network function service and may also send a cryptocurrency transaction to the smart contract. The smart contract may keep track of the entity's usage of the virtual network function service and may periodically (e.g., on a monthly basis) generate billing information to bill the entity for the entity's use of the virtual network function service for a given period (e.g., for a given month).

Using a distributed trust-based network to track an entity's usage of virtual network function services may provide certain technical advantages. Because the entity may send an indication of its usage of virtual network function services to the smart contract every time the entity uses the virtual network function services, the smart contract may track every single time the entity uses the virtual network function services, and may create a record of every single time the entity uses the virtual network function services. This is in contrast to techniques that utilize a Remote Authentication Dial-In User Service (RADIUS) server for authentication, authorization, and accounting (AAA) management and billing of clients, where a RADIUS server may generate billing information based on tracking the usage only a limited number (i.e., few than all) of the virtual network functions of a virtual network function service.

Further, because the distributed trust-based network stores a record of every single time the entity uses the virtual network function services in a distributed ledger, the disclosed system provides increased security for the tracking of the entity's usage of virtual network function services compared with techniques such as using the RADIUS server for such tracking purposes. In a distributed trust-based network, each transaction must be agreed upon by every node in the network before they are recorded in the distributed ledger that is distributed across a network of computers, and after each transaction is approved, it is encrypted and linked to previous transactions. As such, it may be much more difficult for malicious parties to compromise the data recorded into the distributed ledger, thereby increasing the security of the record maintained by the distributed trust-based network in the distributed ledger of every single time the entity uses the virtual network function services.

Further, because all participants of a distributed trust-based network share a copy the distributed ledger, and because the distributed ledger can only be updated through consensus from the participants in the distributed trust-based network, data that is recorded in the distributed ledger may be more accurate, consistent, and transparent than other means of storing data, such as via the RADIUS server. As such, by storing a record of every single time the entity uses the virtual network function services into the distributed ledger, the disclosed system may enhance the accuracy, consistency, and transparency of the record of the entity's usage of virtual network function services that is stored by the disclosed system into the distributed ledger.

Further, a distributed trust-based network may be more reliable and less susceptible to downtime compared with techniques such as using a RADIUS server. Because a distributed trust-based network includes a distributed set of nodes that each includes a copy of the distributed ledger, the distributed trust-based network may be able to continue to track the entity's usage of virtual network function services even when outages occur at a portion of the nodes in the distributed trust-based network, because the remaining nodes of the distributed trust-based network may continue to update the distributed ledger.

In addition, the disclosed system's usage of smart contracts to generate the billing information to bill the entity for the entity's use of the virtual network function service may also provide certain technical advantages compared with other techniques. Because smart contracts may be immutable, a smart contract for generating the billing information to bill the entity for the entity's use of the virtual network function service cannot change how it generates the billing information once it has been created. As such, malicious parties may be unable to change how the smart contract generates the billing information, thereby providing greater security for the disclosed system.

According to certain aspects of the present disclosure, a computer-implemented method for secure and distributed tracking of virtual network function usage using a distributed trust-based network is provided. The method includes receiving, by one or more nodes in a distributed trust-based network, an indication of one or more data transactions by an entity at a virtual network function service and a cryptocurrency transaction from the entity that is associated with the one or more data transactions. The method further includes recording, by a smart contract deployed in the distributed trust-based network, the cryptocurrency transaction in a distributed ledger in the distributed trust-based network. The method further includes tracking, by the smart contract, usage of the virtual network function service by the entity by updating a transaction record associated with the entity in the smart contract to include an amount of data transacted by the virtual network function service for the one or more data transactions, wherein the transaction record is stored in the distributed ledger in the distributed trust-based network. The method further includes generating, by the smart contract, billing information for the usage of the virtual network function service by the entity based at least in part on the transaction record associated with the entity.

According to certain aspects of the present disclosure, a system for secure tracking of virtual network function usage using a distributed trust-based network is provided. The system includes a memory comprising a smart contract. The system further includes a processor configured to execute instructions of the smart contract which, when executed, cause the processor to: receive an indication of one or more data transactions by an entity at a virtual network function service and a cryptocurrency transaction from the entity that is associated with the one or more data transactions; record the cryptocurrency transaction in a distributed ledger in a distributed trust-based network in which the smart contract is deployed; track usage of the virtual network function service by the entity by updating a transaction record associated with the entity in the smart contract to include an amount of data transacted by the virtual network function service for the one or more data transactions, wherein the transaction record is stored in the distributed ledger in the distributed trust-based network; and generate billing information for the usage of the virtual network function service by the entity based at least in part on the transaction record associated with the entity.

According to certain aspects of the present disclosure, a non-transitory machine-readable storage medium comprising machine-readable instructions for causing a processor to execute a method for secure and distributed tracking of virtual network function usage using a distributed trust-based network is provided. The method includes receiving, by one or more nodes in a distributed trust-based network, an indication of one or more data transactions by an entity at a virtual network function service and a cryptocurrency transaction from the entity that is associated with the one or more data transactions. The method further includes recording, by a smart contract deployed in the distributed trust-based network, the cryptocurrency transaction in a distributed ledger in the distributed trust-based network. The method further includes tracking, by the smart contract, usage of the virtual network function service by the entity by updating a transaction record associated with the entity in the smart contract to include an amount of data transacted by the virtual network function service for the one or more data transactions, wherein the transaction record is stored in the distributed ledger in the distributed trust-based network. The method further includes generating, by the smart contract, billing information for the usage of the virtual network function service by the entity based at least in part on the transaction record associated with the entity.

According to certain aspects of the present disclosure, an apparatus for secure tracking of virtual network function usage using a distributed trust-based network is provided. The apparatus includes means for receiving an indication of one or more data transactions by an entity at a virtual network function service and a cryptocurrency transaction from the entity that is associated with the one or more data transactions. The apparatus further includes means for recording the cryptocurrency transaction in a distributed ledger in a distributed trust-based network in which a smart contract is deployed. The apparatus further includes means for tracking usage of the virtual network function service by the entity by updating a transaction record associated with the entity in the smart contract to include an amount of data transacted by the virtual network function service for the one or more data transactions, wherein the transaction record is stored in the distributed ledger in the distributed trust-based network. The apparatus further includes means for generating billing information for the usage of the virtual network function service by the entity based at least in part on the transaction record associated with the entity.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### Example System Architecture

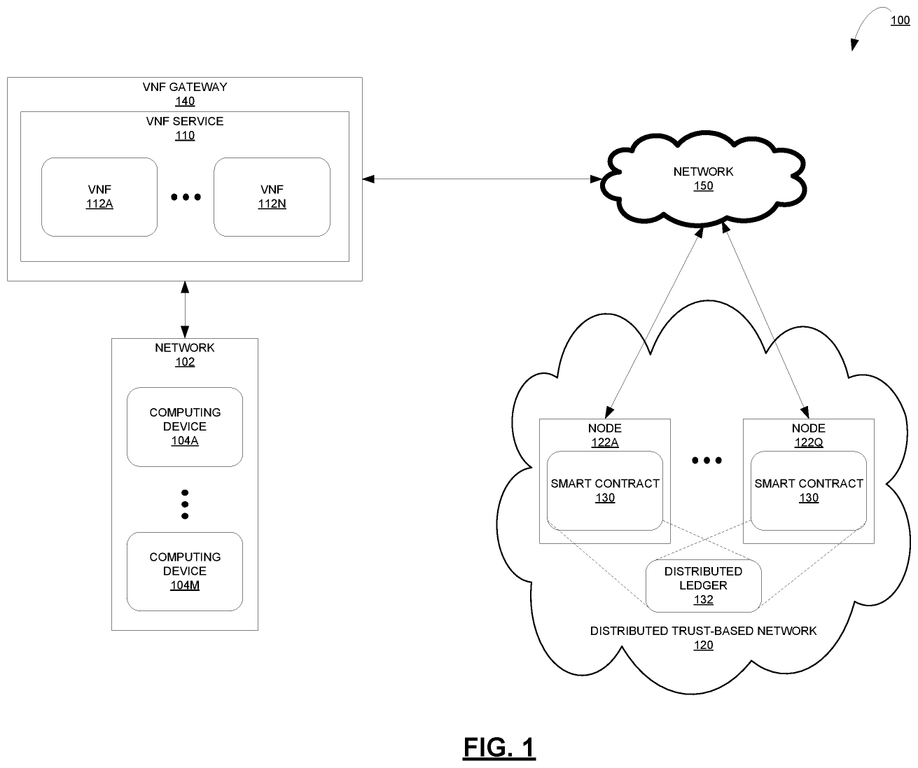

FIG. 1 illustrates an example architecture 100 for secure and distributed tracking of the usage of virtual network function services. The architecture 100 includes distributed trust-based network that is connected to virtual network function (VNF) gateway 140 via network 150, and network 102 that is connected to virtual network function gateway 140.

Virtual network function gateway 140 may provide virtual network function service 110 that is used by network 102. Virtual network function (VNF) service 110 may be a computer-implemented service that provides virtual network functions (VNF) 112A-112N (hereafter “virtual network functions 112”) as a service to entities such as network 102.

The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

Entities such as network 102 that includes computing devices 104A-104M (hereafter “computing devices 104”) may use virtual network function service 110 to utilize certain network functions, such as firewalls, load balancers, deep packet inspectors, network address translators, network caching, domain name systems, and the like, that are provided by virtual network function service 110 for network 102. Virtual network functions are network functions that are virtualized and performed on general purpose computing devices. Virtual network function gateway 140 may be configured to steer or route traffic from network 102 to the appropriate virtual network functions 112 in virtual network function service 110.

Virtual network function gateway 140 can be any device or devices having an appropriate processor, memory, and communications capability for hosting virtual network function service 110. Network 102 may be any suitable network of computing devices 104, such as a LAN. Computing devices 104 in network 102 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities. In certain aspects, virtual network function gateway 140 can be a cloud computing server of an infrastructure-as-a-service (IaaS) and be able to support a platform-as-a-service (PaaS) and software-as-a-service (SaaS) services.

In accordance with aspects of the present disclosure, virtual network function gateway 140 may use distributed trust-based network 120 to track the use of virtual network function service 110 by entities such as network 102, and may use distributed trust-based network 120 to bill entities such as network 102 for their usage of virtual network function service 110.

Distributed trust-based network 120 may be a network that provides an open, distributed ledger that can record transactions between two parties efficiently and in a verifiable and permanent way. Distributed trust-based network 120 may include a peer-to-peer network of nodes 122A-122Q (hereafter “nodes 122”) that participates in peer-to-peer replication of distributed ledger 132. Distributed ledger 132 maybe a consensus of replicated, shared, and synchronized digital data that is spread across nodes 122 of distributed trust-based network.

Each node of nodes 122 may replicate and save an identical copy of distributed ledger 132. When a new transaction is recorded in distributed ledger 132 occurs, each node of node 122 may construct the new transaction in their copy of distributed ledger 132 and then nodes 122 may vote via a consensus algorithm on which copy of distributed ledger 132 is correct. Once nodes 122 reach a consensus on the copy of distributed ledger 132 that is correct, all of the other nodes in nodes 122 may update themselves with the new correct copy of distributed ledger 132. In this way, distributed trust-based network 120 may record transactions and other data in distributed ledger 132. In some examples, distributed trust-based network 120 may be a blockchain network, such as a public blockchain network or a private blockchain network, and distributed ledger 132 may be a blockchain, such as a Bitcoin blockchain or an Ethereum blockchain, a HyperLedger, etc.

In the example of FIG. 1, distributed trust-based network 120 may use distributed ledger 132 to track the usage of virtual network function service 110 by entities such as network 102 via use of smart contract 130 to track and bill for the usage of virtual network function service 110. Smart contract 130 may be a software program that includes code and data that reside at a specific address in a blockchain, such as at a specific address in distributed ledger 132. Each node of nodes 122 in distributed trust-based network 120 may store a copy of the same smart contract 130 in its copy of distributed ledger 132, so that each node of nodes 122 may execute their copy of smart contract 130 when smart contract 130 is called. In one example, smart contract 130 may be an Ethereum smart contract.

Smart contract 130 may that acts as autonomous agents to digitally facilitate, verify, or enforce the negotiation or performance of a contract, and may perform transactions are that trackable and irreversible. The code making up the smart contract 130 may also be immutable, so that the logic and functionality of smart contract 130 cannot be changed once it is deployed in distributed ledger 132.

In accordance with aspects of the present disclosure, each time an entity, such as network 102, interacts with virtual network function gateway 140 to use virtual network functions 112 of virtual network function service 110, the entity may transmit an indication of one or more data transactions that is performed by virtual network function service 110 during the entity's use of virtual network function service 110 to smart contract 130, and may also send a cryptocurrency transaction from the entity to smart contract 130. For example, the entity may use virtual network function gateway 140 to call smart contract 130 using the smart contract 130's address in distributed ledger 132 in order to transmit such data and cryptocurrency transaction to smart contract 130. Examples of cryptocurrency transactions sent from the entity to smart contract 130 may include Bitcoins, Ether, and the like.

Smart contract 130 deployed in distributed trust-based network 120 may receive the indication of one or more data transactions by an entity at virtual network function service 110 and the cryptocurrency transaction from the entity, and may record the cryptocurrency transaction in distributed ledger 132.

Smart contract 130 may also track usage of virtual network function service 110 by the entity by updating a transaction record associated with the entity in smart contract 130 to include an amount of data transacted by virtual network function service 110 for the one or more data transactions, where the transaction record is stored in distributed ledger 132 in distributed trust-based network 120. For example, smart contract 130 may keep a record of the total size of data transacted by virtual network function service 110 for the entity in a specified time period and the total number of data packets transacted by virtual network function service 110 in the specified time period.

Smart contract 130 may, on a periodic basis, generate billing information for the usage of virtual network function service 110 by the entity based at least in part on the transaction record associated with the entity. For example, smart contract may determine an amount to bill the entity based on the total size of data transacted by virtual network function service 110 for the entity in a specified time period and the total number of data packets transacted by virtual network function service 110 in the specified time period as recorded in the transaction record. In this way, virtual network function gateway 140 may use smart contract 130 in distributed trust-based network 120 to track and bill for the usage of virtual network function service 110 by entities such as network 102.

### Example System for Secure Tracking of Virtual Network Function Usage

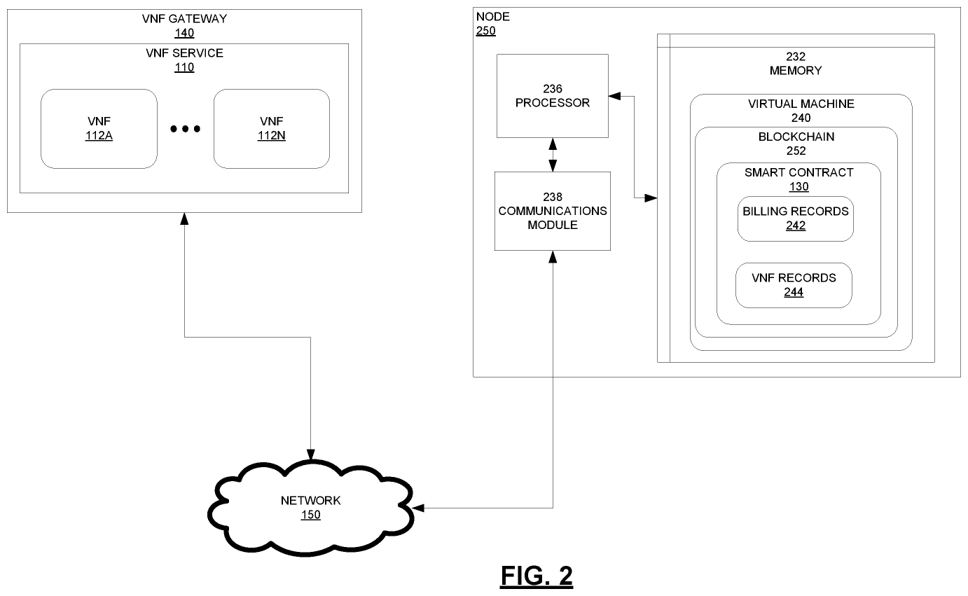

FIG. 2 is a block diagram illustrating an example node 250 in the example distributed trust-based network 120 of FIG. 1 according to certain aspects of the disclosure. As shown in FIG. 2, node 250 is one example of nodes 122 in distributed trust-based network 120 shown in FIG. 1. Node 250 may be connected to virtual network function gateway 140 via network 150. Node 250 may also be connected to other nodes 122 of distributed trust-based network 120 via network 150. As shown in FIG. 2, node 250 includes processor 236, communications module 238, and a memory 232 that includes virtual machine 240, blockchain 252, and smart contract 130. The processor 236 of the node 250 is configured to execute instructions, such as instructions physically coded into the processor 236, instructions received from software in memory 232, or a combination of both.

Smart contract 130 may be code that is compiled into bytecode that is executed by virtual machine 240. For example, virtual machine 240 may be an Ethereum virtual machine and smart contract may be compiled by a compiler into Ethereum bytecode that is executable by virtual machine 240. Blockchain 252, which is an example of distributed ledger 132, includes a list of records, also referred to as blocks, which are linked together by cryptography. Blockchain 252 may be able to record transactions between parties, such as cryptocurrency transactions between parties, as well as other transaction data.

When an entity uses the virtual network function service 110 to perform a function for its network, such as network 102, the entity may communicate with smart contract 130 to send an indication of the one or more data transactions performed by the entity at virtual network function service 110 and may also send a cryptocurrency transaction from the entity's crypto wallet that is associated with the one or more data transactions to smart contract 130. For example, the entity may use virtual network function gateway 140 to call a function in smart contract 130 to send an indication of the one or more data transactions performed by the entity at virtual network function service 110 to smart wallet 130 as well as to send a cryptocurrency transaction from the entity's crypto wallet that is associated with the one or more data transactions to smart contract 130.

Processor 236 of node 250 may execute instructions of smart contract 130 to receive, via communications module 238, an indication of one or more data transactions by an entity at a virtual network function service 110 and a cryptocurrency transaction from the entity that is associated with the one or more data transactions. The indication of the one or more data transactions performed by the entity may include a size of the data, such as in bytes, transacted by virtual network function service 110 to perform the one or more data transactions, the number of data packets transacted by virtual network function service 110 to perform the one or more data transactions, or both.

For example, when the entity uses virtual network function service 110 to perform a network function, virtual network function service 110 may send and receive a certain amount of data to and from network 150 to perform the network function, and may also send and receive a certain number of data packets to and from network 150 to perform the network function. Virtual network function gateway 140 may keep track of the size of the data transacted by virtual network function service 110 to perform the one or more data transactions and may also keep track of the number of data packets transacted by virtual network function service 110 to perform the one or more data transactions, and may send indications of the size of the data transacted by virtual network function service 110 to perform the one or more data transactions and the number of data packets transacted by virtual network function service 110 to perform the one or more data transactions to smart contract 130.

The cryptocurrency transaction received from the entity may include Bitcoin transactions, Ether transactions, and the like. The amount of the cryptocurrency transaction received from the entity may depend on whether the entity is a prepaid entity or a postpaid entity. A prepaid entity may pay the rate charged by the vendor of virtual network function service 110 for performance of the one or more data transactions by virtual network function service 110 when virtual network function service 110 performs the one or more transactions. Thus, for a prepaid entity, the amount of the cryptocurrency transaction received from the prepaid entity may be a billing rate that is charged by the vendor of virtual network function service 110 for performance of the one or more data transactions by virtual network function service 110. The billing rate that is charged by the vendor may be determined via a formula that takes into account the size of the data transacted by virtual network function service 110 to perform the one or more data transactions and the number of data packets transacted by virtual network function service 110 to perform the one or more data transactions.

If the entity is a postpaid entity, smart contract 130 may periodically bill the entity for its usage of virtual network function service 110 in a given time period, such as on a monthly basis. As such, a postpaid entity may not pay the rate charged by the vendor of virtual network function service 110 for performance of the one or more data transactions by virtual network function service 110 when virtual network function service 110 performs the one or more transactions. Instead, the cryptocurrency transaction received from the postpaid entity may be of an amount that is needed to pay other nodes of distributed trust-based network to perform the various transactions required by smart contract 130, such as to record various information to distributed ledger 132.

Processor 236 of node 250 may execute instructions of smart contract 130 to record the cryptocurrency transaction received from the entity in distributed ledger 132, such as blockchain 252, in distributed trust-based network 120. For example, processor 236 of node 250 may execute instructions to broadcast the cryptocurrency transaction, so that other nodes 122 of distributed trust-based network 120 may record the cryptocurrency transaction for smart contract 130 in their copy of distributed ledger 132 and so that nodes 122 may communicate amongst themselves in a peer-to-peer fashion in order to come to a consensus regarding the recordation of the cryptocurrency transaction.

Processor 236 of node 250 may execute instructions of smart contract 130 to track usage of virtual network function service 110 by the entity by updating a transaction record associated with the entity in smart contract 130 to include an amount of data transacted by virtual network function service 110 for the one or more data transactions. Smart contract 130 may track the usage of virtual network function services provided by the vendor by a plurality of entities by providing a plurality of transaction records associated with the plurality of entities in the transaction record. Thus, if smart contract 130 tracks ten entities, smart contract 130 may include ten transaction records associated with the ten entities.

The transaction record associated with smart contract 130 may include a billing record in billing records 242 and a virtual network function record in virtual network function records 244. Billing records 242 may store information associated with the total amount of data transacted by virtual network function service 110, for entities, while virtual network function records 244 may store information associated with the virtual network functions 112 in virtual network function service 110 provisioned by entities.

For example, a billing record associated with the entity in billing records 242 may include information such as the total size of data transacted by virtual network function service 110 for the entity in the current billing period and the total number of data packets transacted by virtual network function service 110 for the entity in the current billing period. Processor 236 may execute smart contract 130 to update the billing record associated with the entity in billing records 242 by adding the size of the data transacted by virtual network function service 110 to perform the one or more data transactions to the total size of the data transacted by virtual network function service 110 for the entity. Processor 236 may also execute smart contract 130 to update the billing record associated with the entity in billing records 242 by adding the number of data packets transacted by virtual network function service 110 to perform the one or more data transactions to the total number of data packets transacted by virtual network function service 110 for the entity in the current billing period. The billing record associated with the entity may be stored in distributed ledger 132, such as blockchain 252, in distributed trust-based network 120.

Processor 236 of node 250 may execute instructions of smart contract 130 to generate billing information for the usage of virtual network function service 110 by the entity based at least in part on the transaction record associated with the entity. Smart contract 130 may generate the billing information for the usage of virtual network function service 110 by the entity on a periodic basis, such as on a monthly basis, so that smart contract 130 may, for each month, generate billing information for the usage of virtual network function service 110 by the entity for that month. Smart contract 130 may not generate billing information for entities that are prepaid entities because prepaid entities may pay for their usage of virtual network function service 110 as they use virtual network function service 110.

Processor 236 may execute smart contract 130 to generate, for a prepaid entity, a billing information that includes a billing rate of zero because prepaid entity pays for its usage of virtual network function service 110 as the prepaid entity users such services. In contrast, processor 236 may execute smart contract 130 to generate, for a postpaid entity, a billing information that includes a billing rate that is based at least in part on the total amount of data transacted by virtual network function service 110 for the entity as recorded in billing records 242 and the total number of data packets transacted by virtual network function service 110 for the entity as recorded in billing records 242. Thus, for a given time period (e.g., a month), the billing rate for the entity may be based on a formula that takes into account the total amount of data transacted by virtual network function service 110 for the entity during the time period and the total number of data packets transacted by virtual network function service 110 for the entity during the time period.

In some examples, an entity may provision additional virtual network functions in virtual network function service 110 to provide additional network functions for network 102 associated with the entity, and the vendor of virtual network function service 110 may correspondingly bill the entity for the provisioning of additional virtual network functions in virtual network function service 110. When the entity provisions an additional virtual network function in virtual network function service 110, the entity may send an indication of the entity provisioning the additional virtual network function in virtual network function service 110 to smart contract 130 along with a cryptocurrency transaction associated with the provisioning of the additional virtual network function.

Processor 236 may execute smart contract 130 to receive an indication of the entity provisioning the additional virtual network function in virtual network function service 110 and the cryptocurrency transaction from the entity that is associated with the provisioning of the additional virtual network function. Processor 236 may execute smart contract 130 to track virtual network functions that are provisioned by the entity by updating the transaction record associated with the entity in smart contract 130 with the indication of the additional virtual network function provisioned by the entity in virtual network function service 110. In particular, processor 236 may update a record associated with the entity in virtual network function records 244 to indicate the additional virtual network function provisioned by the entity in virtual network function service 110. When processor 236 executes smart contract 130 to generate billing information for the entity for a time period, processor 236 may execute smart contract 130 to take into account the number of additional virtual network functions provisioned by the entity during that time period as indicated in the record associated with the entity in virtual network function records 244.

An example pseudo code of smart contract 130 is shown below:

// The following is the pseudocode for the smart contract
deployed by the Vendor for each customer.
// It also holds state (billingRecord[ ] and vnfRecord[ ]
structures) which is tracking which customer deposited what
amount. We have
// shown these structs as an array, where each index stores a
customer, but the Vendor could deploy a smart contract per
customer, in
// which case the array[ ] is not needed, since the contract is
per customer.
pragma solidity \hat{ }0.4.11;
// This contract contains two member variables, a constructor
and 1 billing function and 1 destruct function.
// The constructor will be called once upon contract
deployment, sets the owner of the contract owner to the sender
of the transaction
contract billing {

address public vendor; // The vendor that created this

contract. The address of the contract is stored here, and
filled in the constructor.

// The following stores the customer state/data that the

customer sends periodically to the contract.

| | |
|---|---|
| billingStruct | billingRecord[ ] |

| | |
|---|---|
| vnfStruct | vnfRecord[ ] |

// constructor function called for each enterprise customer
contract.
// This function is called by the creator of the contract - in
our case, the Vendor of the equipment, like HPE.

function billing (string _message, customerId id, Boolean

prepaid) public {
vendor = msg.sender; // This is where the above public global
variable gets its value
billingRecord[id].prePaidCustomer = prepaid;
billingRecord[id] = id;

}

// Increment billing record. This could be either prepaid or
post-paid, depending on how the Vendor treats the Contract
ether being passed in the payable function.
// There are two different ways to interact with smart
contracts on the Ethereum blockchain.
// This billing function is an ethereum ‘execute’ function
that needs to have a “payable” keyword

function billing_record (customerId id, int value, int

pkts, int bytes) payable returns(bool success) {
billingRecord[id].time = date;
billingRecord[id].customerAddress = msg.sender;
// In case of prepaid customer, msg.value is the ether
transferred to the Contract.
billingRecord[id].value += msg.value // this is the ether that
has been passed by the vendor device in the enterprise based
on pkts
owner.transfer(msg.value);
// In case of postpaid, msg.value is just the amount of ether
to run the transaction, but the other data is computed and
calculated to be
// billed to the Vendor after a month.
billingRecord[id].numPkts += pkts
billingRecord[id].numBytes += bytes;
billingRecord[id].bill = <an equation to convert numPkts and
numBytes into postpaid bill>
billingRecord[id].value + msg.value // although in this case
the ether transferred is not real money, since it is postpaid
return true;

}

// This is a read only function - called to get the bill for a
customer
function getPostPaidBill(customerId id) {

return billingRecord[id].bill

}
// Add VNF to Controller - also needs ether to be sent to the
contract

function vnf_record (customerId id, int value) payable

returns(bool success) {
vnfRecord[id].time = date;
vnfRecord[id].customerAddress = msg.sender;
owner.transfer(msg.value);
return true;

}

// This function allows the creator of the contract to self
destruct the contract and clean up the state.
function kill_contract ( ) {

if (msg.sender == owner) {

selfdestruct(owner);

}

}

}

In the pseudo code shown above, the vendor of virtual network function services 110 may call the constructor function to create smart contract 130 associated with the vendor of virtual network function services 110. When processor 236 executes the constructor function, processor 236 may create two data structures: bill ingRecord [ ] and vnfRecord [ ], which corresponds to billing records 242 and virtual network function records 244, respectively. bill ingRecord[ ] and vnfRecord[ ] may each be an array of records, such that bill ingRecord[ ] and vnfRecord[ ] may each store the records of multiple entities that uses virtual network functions services provided by the vender associated with smart contract 130.

The vendor that creates smart contract 130 may also call the billing( ) function to provide information regarding the entities that use virtual network function services (e.g., virtual network function services 110) provided by the vendor. For example, processor 236 may execute the billing( ) function to populate a bill ingRecord[ ] record for an entity with an identifier for the entity and an indication of whether the entity is a prepaid entity or a postpaid entity.

When an entity uses the virtual network functions 112 provided by virtual network function services 110, the entity may call the billing_record( ) function to send to smart contract 130 an indication of one or more data transactions by the entity at virtual network function service 110. Because the billing_record( ) function is an “execute” function with a “payable” keyword, smart contract 130 may require that the entity also send a cryptocurrency transaction to smart contract 130 when calling the billing_record( ) function.

When calling the billing_record( ) function, the entity may provide parameters such as its customer identifier, the number of data packets sent and received by virtual network function service 110 to perform the requested virtual network function, the size of the data sent and received by virtual network function service 110 to perform the requested virtual network function, and the like.

Processor 236 may execute the billing_record( ) function to update the record of the total number of data packets sent and received by virtual network function service 110 to perform virtual network functions for the entity and the total size of the data sent and received by virtual network function service 110 to perform virtual network functions for the entity as stored in by adding the number of data packets sent and received by virtual network function service 110 to perform the requested virtual network function to the current number of data packets sent and received by virtual network function service 110 to perform virtual network functions 112 for the entity as stored in bill ingRecord[ ], and by adding the size of the data sent and received by virtual network function service 110 to perform the requested virtual network function to the current size of the data sent and received by virtual network function service 110 to perform virtual network functions 112 for the entity as stored in bill ingRecord[ ].

If the entity is a prepaid entity, processor 236 may also execute the billing_record( ) function to send the cryptocurrency transaction received from the entity as part of calling the billing_record( ) function to the vendor's crypto wallet. If the entity is a prepaid entity, processor 236 may also execute the billing_record( ) function to calculate billing information for the entity based on the total number of data packets sent and received by virtual network function service 110 to perform virtual network functions 112 for the entity as stored in billingRecord[ ] and the total size of the data sent and received by virtual network function service 110 to perform virtual network functions 112 for the entity as stored in bill ingRecord[ ], such as by using a specified formula to convert the total size of the data and the total number of data packets into an amount of money that is to be billed to the entity.

An entity that is a postpaid entity may call the get PostPaidBill( ) function with the customer identifier associated with the entity as a parameter to retrieve the billing formation for the entity. Processor 236 may execute the get Post PaidBill( ) function to retrieve and return the billing information as calculated in the billing_record( ) function.

When an entity provisions an additional virtual network function in virtual network function services 110, the entity may call the vnf_record( ) function and may send a cryptocurrency transaction to smart contract 130 to pay for the use of the newly provisioned virtual network function. Processor 236 may execute the vnf_record( ) function to receive the cryptocurrency transaction and to send the cryptocurrency transaction to the vendor's crypto wallet. Processor 236 may execute the vnf_record( ) function to update the entity's record in vnfRecord[ ] to indicate that the entity has provisioned the additional virtual network function in virtual network function services 110.

In some examples, smart contract 130 also includes a destructor function kill_contract( ) that the vendor of virtual network function services 110 may call to delete smart contract 130. Processor 236 may execute the destructor function to determine whether the destructor function is called by the vendor associated with smart contract 130 and, if so, may delete smart contract 130 from distributed trust-based network 120.

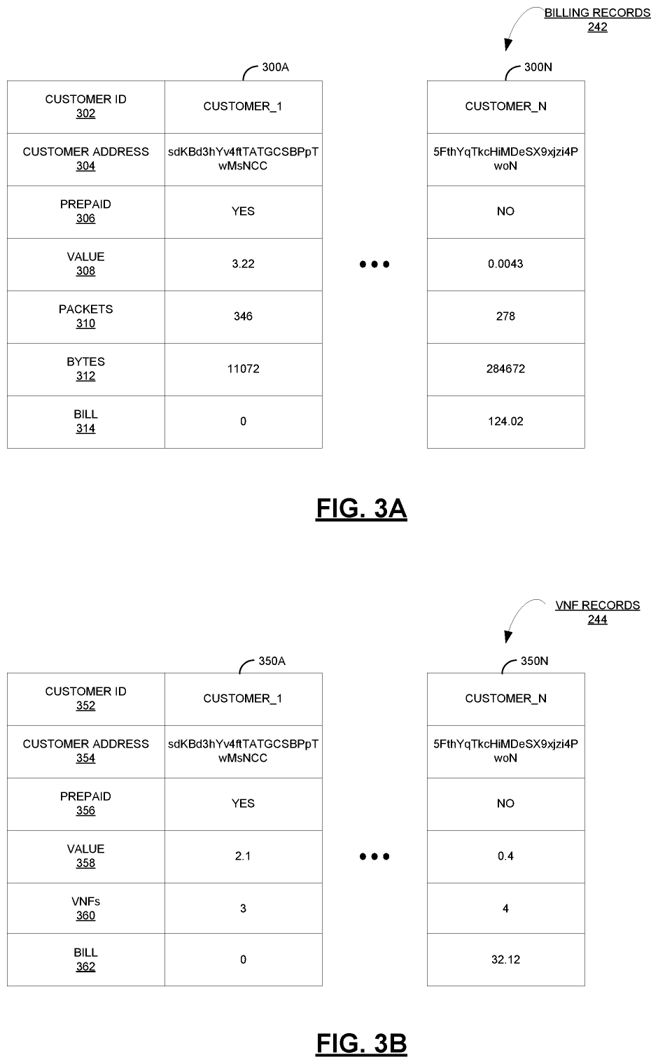

FIG. 3A illustrates the example billing records 242 shown in FIG. 2. As shown in FIG. 3A, billing records 242 may include billing records 300A-300N (hereafter “billing records 300”) that smart contract 130 may use to track a plurality of entities that use virtual network function services, such as virtual network function service 110, provided by a vendor associated with smart contract 130. Each billing record of billing records 300 may include customer identifier field 302, customer address field 304, prepaid field 306, value field 308, packets field 310, bytes field 312, and bill field 314.

Customer identifier field 302 in a billing record may store an identifier for the entity associated with the billing record. Customer address field 304 may store the crypto wallet address for the entity associated with the billing record. Prepaid field 306 may store an indication of whether the entity associated with the billing record is a prepaid entity or a postpaid entity. Value field 308 may store the amount of cryptocurrency sent by the entity associated with the billing record to smart contract 130. A prepaid entity may send a relatively large amount of cryptocurrency to smart contract 130, while a postpaid entity may send a relatively small amount of cryptocurrency to smart contract 130.

Packets field 310 may store the total number of data packets in a billing period that were transacted by a virtual network function service provided by the vendor for the entity associated with the billing record. Bytes field 312 may store the total size of data in a billing period that were transacted by a virtual network function service provided by the vendor for the entity associated with the billing record. Bill field 314 may store the total amount of money owed by the entity associated with the billing record for the usage of virtual network function services provided by the vendor during the billing period to the vendor. For example, a prepaid entity may not owe any money to the vendor.

FIG. 3B illustrates the example virtual network function records 244 shown in FIG. 2. As shown in FIG. 3A, virtual network function records 244 may include virtual network function records 350A-350N (hereafter “virtual network function records 350”) that smart contract 130 may use to track a plurality of entities that may provision additional virtual network functions in virtual network function services, such as virtual network function service 110, provided by a vendor associated with smart contract 130. Each virtual network function record of virtual network function records 350 may include customer identifier field 352, customer address field 354, prepaid field 356, value field 358, virtual network function field 360, and bill field 362.

Customer identifier field 352 in a virtual network function record may store an identifier for the entity associated with the virtual network function record. Customer address field 354 may store the crypto wallet address for the entity associated with the virtual network function record. Prepaid field 356 may store an indication of whether the entity associated with the virtual network function record is a prepaid entity or a postpaid entity. Value field 358 may store the amount of cryptocurrency sent by the entity associated with the virtual network function record to smart contract 130. A prepaid entity may send a relatively large amount of cryptocurrency to smart contract 130, while a postpaid entity may send a relatively small amount of cryptocurrency to smart contract 130.

Virtual network function field 360 may store the total number of additional virtual network functions that were provisioned by the entity associated with the virtual network function record in a billing period. Bill field 362 may store the total amount of money owed by the entity associated with the virtual network function record for the provisioning of additional virtual network functions in the virtual network function services provided by the vendor during the billing period to the vendor. For example, a prepaid entity may not owe any money to the vendor.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

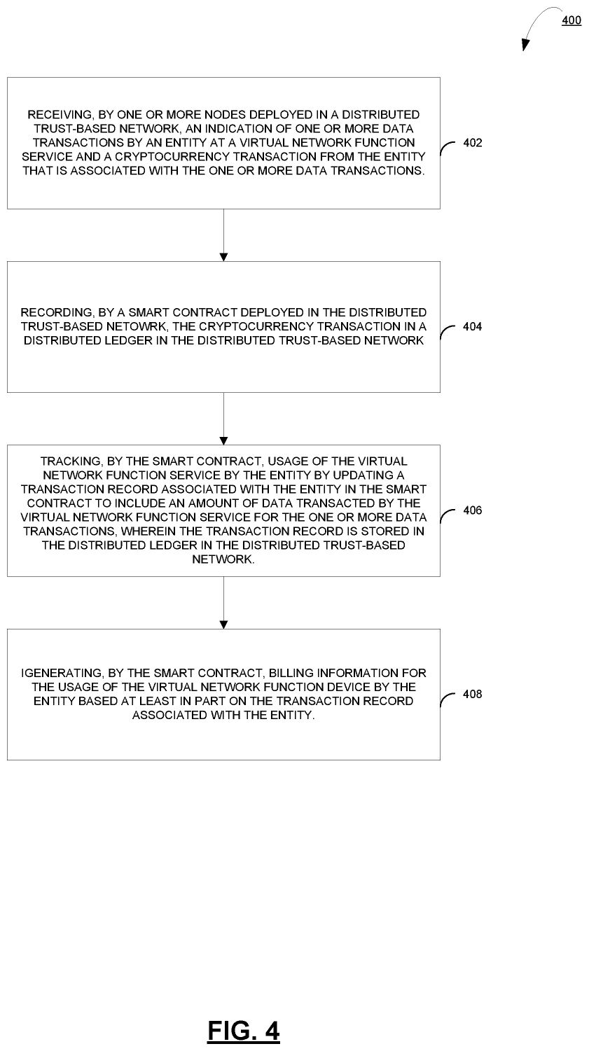

FIG. 4 illustrates an example process 400 for secure and distributed tracking of virtual network function using the example node 250 of FIG. 2 in the example distributed trust-based network 120 of FIG. 1. While FIG. 4 is described with reference to FIGS. 1 and 2, it should be noted that the process steps of FIG. 4 may be performed by other systems. For example, in the case where distributed trust-based network 120 is a blockchain network, each node of nodes 122 in the blockchain network may perform the example process 400.

The process 400 begins by proceeding to step 402 where one or more nodes 122 in distributed trust-based network 120 may receive an indication of one or more data transactions by an entity at virtual network function service 110 and a cryptocurrency transaction from the entity that is associated with the one or more data transactions.

In some examples, one or more nodes 122 receiving the indication of one or more data transactions by the entity at virtual network function service 110 may further include smart contract 130 receiving at least one of: a size of data transacted by virtual network function service 110 to perform the one or more data transactions or a number of packets transacted by virtual network function service 110 to perform the one or more data transactions.

The process 400 proceeds to step 404 where smart contract 130 deployed in distributed trust-based network 120 may record the cryptocurrency transaction in distributed ledger 132 in distributed trust-based network 120. In some examples, an amount of the cryptocurrency transaction received from the entity corresponds to a billing rate that is charged by a vendor of virtual network function service 110 for performance of the one or more data transactions by virtual network function service 110.

The process 400 proceeds to step 406 where smart contract 130 may track usage of virtual network function service 110 by the entity by updating a transaction record associated with the entity in smart contract 130 to include an amount of data transacted by virtual network function service 110 for the one or more data transactions, where the transaction record is stored in distributed ledger 132 in distributed trust-based network 120. In some examples, distributed trust-based network 120 comprises a blockchain network, and wherein distributed ledger 132 in distributed trust-based network 120 comprises blockchain 252.

In some examples, smart contract 130 updating the transaction record associated with the entity in smart contract 130 to include the amount of data transacted by virtual network function service 110 for the one or more data transactions includes at least one of: adding the number of packets transacted by virtual network function service 110 to a total amount of data transacted by virtual network function service 110 in the transaction record associated with the entity or adding the number of packets transacted by virtual network function service 110 to perform the one or more data transactions to a total number of data packets transacted by virtual network function service 110 in the transaction record associated with the entity.

In some examples, smart contract 130 may track usage of virtual network function service 110 by a plurality of entities by updating a plurality of transaction records associated with the plurality of entities in smart contract 130, where the plurality of transaction records are stored in distributed ledger 132 of distributed trust-based network 120.

The process proceeds to step 408 where smart contract may generate billing information for the usage of virtual network function service 110 by the entity based at least in part on the transaction record associated with the entity.

In some examples, smart contract 130 generating the billing information for the entity based at least in part on the transaction record associated with the entity further includes smart contract 130 generating the billing information for the entity based at least in part on the total amount of data transacted by virtual network function service 110 in the transaction record associated with the entity and the total number of data packets transacted by virtual network function service 110 in the transaction record associated with the entity.

In some examples, smart contract 130 may receive an indication of the entity provisioning an additional virtual network function in virtual network function service 110 and a second cryptocurrency transaction from the entity that is associated with the provisioning of the additional virtual network function. Smart contract 130 may track virtual network functions that are provisioned by the entity by updating the transaction record associated with the entity in smart contract 130 with the indication of the additional virtual network function provisioned by the entity in virtual network function service 110.

### Hardware Overview

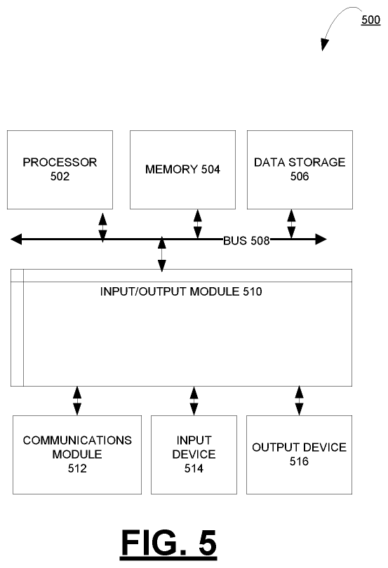

FIG. 5 is a block diagram illustrating an example computer system 500 with which example nodes 122 and example node 250 in FIGS. 1 and 2 can be implemented. In certain aspects, the computer system 500 may be implemented using hardware or a combination of software and hardware, either in a dedicated server, or integrated into another entity, or distributed across multiple entities.

Computer system 500 (e.g., node 250) includes a bus 508 or other communication mechanism for communicating information, and a processor 502 (e.g., processor 212 and 236) coupled with bus 508 for processing information. According to one aspect, the computer system 500 can be a cloud computing server of an IaaS that is able to support PaaS and SaaS services. According to one aspect, the computer system 500 is implemented as one or more special-purpose computing devices. The special-purpose computing device may be hard-wired to perform the disclosed techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. By way of example, the computer system 500 may be implemented with one or more processors 502. Processor 502 may be a general-purpose microprocessor, a microcontroller, a Digital Signal Processor (DSP), an ASIC, a FPGA, a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry. Expansion memory may also be provided and connected to computer system 500 through input/output module 510, which may include, for example, a SIMM (Single In Line Memory Module) card interface. Such expansion memory may provide extra storage space for computer system 500, or may also store applications or other information for computer system 500. Specifically, expansion memory may include instructions to carry out or supplement the processes described above, and may include secure information also. Thus, for example, expansion memory may be provided as a security module for computer system 500, and may be programmed with instructions that permit secure use of computer system 500. In addition, secure applications may be provided via the SIMM cards, along with additional information, such as placing identifying information on the SIMM card in a non-hackable manner.

The instructions may be stored in the memory 504 and implemented in one or more computer program products, e.g., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. In addition, input/output module 510 may be provided in communication with processor 502, so as to enable near area communication of computer system 500 with other devices. The input/output module 510 may provide, for example, for wired communication in some implementations, or for wireless communication in other implementations, and multiple interfaces may also be used. The input/output module 510 is configured to connect to a communications module 512. Example communications modules 512 (e.g., communications module 238) include networking interface cards, such as Ethernet cards and modems.

The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

For example, in certain aspects, communications module 512 can provide a two-way data communication coupling to a network link that is connected to a local network. Wireless links and wireless communication may also be implemented. Wireless communication may be provided under various modes or protocols, such as GSM (Global System for Mobile Communications), Short Message Service (SMS), Enhanced Messaging Service (EMS), or Multimedia Messaging Service (MMS) messaging, CDMA (Code Division Multiple Access), Time division multiple access (TDMA), Personal Digital Cellular (PDC), Wideband CDMA, General Packet Radio Service (GPRS), or LTE (Long-Term Evolution), among others. Such communication may occur, for example, through a radio-frequency transceiver. In addition, short-range communication may occur, such as using a BLUETOOTH, WI-FI, or other such transceiver.

In any such implementation, communications module 512 sends and receives electrical, electromagnetic or optical signals that carry digital data streams representing various types of information. The network link typically provides data communication through one or more networks to other data devices. For example, the network link of the communications module 512 may provide a connection through local network to a host computer or to data equipment operated by an Internet Service Provider (ISP). The ISP in turn provides data communication services through the world wide packet data communication network now commonly referred to as the “Internet”. The local network and Internet both use electrical, electromagnetic or optical signals that carry digital data streams. The signals through the various networks and the signals on the network link and through communications module 512, which carry the digital data to and from computer system 500, are example forms of transmission media.

Computer system 500 can send messages and receive data, including program code, through the network(s), the network link and communications module 512. In the Internet example, a server might transmit a requested code for an application program through Internet, the ISP, the local network and communications module 512. The received code may be executed by processor 502 as it is received, and/or stored in data storage 506 for later execution.

In certain aspects, the input/output module 510 is configured to connect to a plurality of devices, such as an input device 514 and/or an output device 516. Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), LCD (liquid crystal display) screen, a TFT LCD (Thin-Film-Transistor Liquid Crystal Display) or an OLED (Organic Light Emitting Diode) display, for displaying information to the user. The output device 516 may comprise appropriate circuitry for driving the output device 516 to present graphical and other information to a user.

According to one aspect of the present disclosure, nodes 122 of distributed trust-based network 120 shown in FIG. 1, such as node 250 shown in FIG. 2, can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. Processor 502 may process the executable instructions and/or data structures by remotely accessing the computer program product, for example by downloading the executable instructions and/or data structures from a remote server through communications module 512 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer-readable medium” as used herein refers to any medium or media that participates in providing instructions or data to processor 502 for execution. The term “storage medium” as used herein refers to any non-transitory media that store data and/or instructions that cause a machine to operate in a specific fashion. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 508. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for secure and distributed tracking of virtual network function usage using a distributed trust-based network, the method comprising:
receiving, by at least one node in a distributed trust-based network, an indication of one or more data transactions by an entity at a virtual network function service and a cryptocurrency transaction from the entity that is associated with the one or more data transactions;
recording, by a smart contract deployed in the distributed trust-based network, the cryptocurrency transaction in a distributed ledger in the distributed trust-based network;
tracking, by the smart contract, usage of the virtual network function service by the entity by updating a transaction record associated with the entity in the smart contract to include an amount of data transacted by the virtual network function service for the one or more data transactions, wherein the transaction record is stored in the distributed ledger in the distributed trust-based network; and
generating, by the smart contract, billing information for the usage of the virtual network function service by the entity based at least in part on the transaction record associated with the entity.

2. The computer-implemented method of claim 1, wherein receiving the indication of one or more data transactions by the entity at the virtual network function service further comprises:
receiving, by the at least one node, at least one of: a size of data transacted by the virtual network function service to perform the one or more data transactions or a number of data packets transacted by the virtual network function service to perform the one or more data transactions.

3. The computer-implemented method of claim 2, wherein updating the transaction record associated with the entity in the smart contract to include the amount of data transacted by the virtual network function service for the one or more data transactions includes at least one of:
adding, by the smart contract, the size of data transacted by the virtual network function service to a total size of data transacted by the virtual network function service in the transaction record associated with the entity, or
adding, by the smart contract, the number of data packets transacted by the virtual network function service to perform the one or more data transactions to a total number of data packets transacted by the virtual network function service in the transaction record associated with the entity.

4. The computer-implemented method of claim 3, wherein generating the billing information for the entity based at least in part on the transaction record associated with the entity further comprises:
generating, by the smart contract, the billing information for the entity based at least in part on the total size of data transacted by the virtual network function service in the transaction record associated with the entity and the total number of data packets transacted by the virtual network function service in the transaction record associated with the entity.

5. The computer-implemented method of claim 1, further comprising:
receiving, by the at least one node, an indication of the entity provisioning an additional virtual network function in the virtual network function service and a second cryptocurrency transaction from the entity that is associated with the provisioning of the additional virtual network function;
tracking, by the smart contract, virtual network functions that are provisioned by the entity by updating the transaction record associated with the entity in the smart contract with the indication of the additional virtual network function provisioned by the entity in the virtual network function service.

6. The computer-implemented method of claim 1, further comprising:
tracking, by the smart contract, usage of the virtual network function service by a plurality of entities by updating a plurality of transaction records associated with the plurality of entities in the smart contract, wherein the plurality of transaction records are stored in the distributed ledger of the distributed trust-based network.

7. The computer-implemented method of claim 1, wherein an amount of the cryptocurrency transaction received from the entity corresponds to a billing rate that is charged by a vendor of the virtual network function service for performance of the one or more data transactions by the virtual network function service.

8. The computer-implemented method of claim 1, wherein the distributed trust-based network comprises a blockchain network, and wherein the distributed ledger comprises a blockchain.

9. A system for secure tracking of virtual network function usage using a distributed trust-based network, comprising:
a memory comprising a smart contract; and
a processor configured to execute instructions of the smart contract which, when executed, cause the processor to:
receive an indication of one or more data transactions by an entity at a virtual network function service and a cryptocurrency transaction from the entity that is associated with the one or more data transactions;
record the cryptocurrency transaction in a distributed ledger in a distributed trust-based network in which the smart contract is deployed;
track usage of the virtual network function service by the entity by updating a transaction record associated with the entity in the smart contract to include an amount of data transacted by the virtual network function service for the one or more data transactions, wherein the transaction record is stored in the distributed ledger in the distributed trust-based network; and
generate billing information for the usage of the virtual network function service by the entity based at least in part on the transaction record associated with the entity.

10. The system of claim 9, wherein the instructions of the smart contract which, when executed, cause the processor to receive the indication of one or more data transactions by the entity at the virtual network function service further cause the processor to:
receive at least one of: a size of data transacted by the virtual network function service to perform the one or more data transactions or a number of packets transacted by the virtual network function service to perform the one or more data transactions.

11. The system of claim 10, wherein the instructions of the smart contract which, when executed, cause the processor to update the transaction record associated with the entity in the smart contract to include the amount of data transacted by the virtual network function service for the one or more data transactions further cause the processor to at least one of:
add the size of data transacted by the virtual network function service to a total size of data transacted by the virtual network function service in the transaction record associated with the entity, or
add the number of data packets transacted by the virtual network function service to perform the one or more data transactions to a total number of data packets transacted by the virtual network function service in the transaction record associated with the entity.

12. The system of claim 11, wherein the instructions of the smart contract which, when executed, cause the processor to generate the billing information for the entity based at least in part on the transaction record associated with the entity further cause the processor to:
generate the billing information for the entity based at least in part on the total size of data transacted by the virtual network function service in the transaction record associated with the entity and the total number of data packets transacted by the virtual network function service in the transaction record associated with the entity.

13. The system of claim 9, wherein the instructions of the smart contract, when executed, further cause the processor to:
receive an indication of the entity provisioning an additional virtual network function in the virtual network function service and a second cryptocurrency transaction from the entity that is associated with the provisioning of the additional virtual network function; and
track virtual network functions that are provisioned by the entity by updating the transaction record associated with the entity in the smart contract with the indication of the additional virtual network function provisioned by the entity in the virtual network function service.

14. The system of claim 9, wherein the instructions of the smart contract, when executed, further cause the processor to:
track usage of the virtual network function service by a plurality of entities by updating a plurality of transaction records associated with the plurality of entities in the smart contract, wherein the plurality of transaction records are stored in the distributed ledger of the distributed trust-based network.

15. The system of claim 9, wherein an amount of the cryptocurrency transaction received from the entity corresponds to a billing rate that is charged by a vendor of the virtual network function device for performance of the one or more data transactions by the virtual network function service.

16. The system of claim 9, wherein the distributed trust-based network comprises a blockchain network, and wherein the distributed ledger comprises a blockchain.

17. A non-transitory machine-readable storage medium comprising machine-readable instructions for causing a processor to execute a method for secure and distributed tracking of virtual network function usage using a distributed trust-based network, comprising:
receiving, by one or more nodes in a distributed trust-based network, an indication of one or more data transactions by an entity at a virtual network function service and a cryptocurrency transaction from the entity that is associated with the one or more data transactions;
recording, by a smart contract deployed in the distributed trust-based network, the cryptocurrency transaction in a distributed ledger in the distributed trust-based network;
tracking, by the smart contract, usage of the virtual network function service by the entity by updating a transaction record associated with the entity in the smart contract to include an amount of data transacted by the virtual network function service for the one or more data transactions, wherein the transaction record is stored in the distributed ledger in the distributed trust-based network; and
generating, by the smart contract, billing information for the usage of the virtual network function service by the entity based at least in part on the transaction record associated with the entity.

18. The non-transitory machine-readable storage medium of claim 17, wherein receiving the indication of one or more data transactions by the entity at the virtual network function service further comprises:
receiving, by the smart contract, at least one of: a size of data transacted by the virtual network function service to perform the one or more data transactions or a number of packets transacted by the virtual network function service to perform the one or more data transactions.

19. The non-transitory machine-readable storage medium of claim 18, wherein updating the transaction record associated with the entity in the smart contract to include the amount of data transacted by the virtual network function service for the one or more data transactions includes at least one of:
adding, by the smart contract, the size of data transacted by the virtual network function service to a total size of data transacted by the virtual network function service in the transaction record associated with the entity, or
adding, by the smart contract, the number of data packets transacted by the virtual network function service to perform the one or more data transactions to a total number of data packets transacted by the virtual network function service in the transaction record associated with the entity.

20. The non-transitory machine-readable storage medium of claim 19, wherein generating the billing information for the entity based at least in part on the transaction record associated with the entity further comprises:
generating, by the smart contract, the billing information for the entity based at least in part on the total size of data transacted by the virtual network function service in the transaction record associated with the entity and the total number of data packets transacted by the virtual network function service in the transaction record associated with the entity.
